(19) United States
(12) Patent Application Publication
(10) Pub. No.: US 2007/0065646 A1
(43) Pub. Date: Mar. 22, 2007

(54) Method of fabricating high-gloss liqui-finish artwork prints

(75) Inventor: Michael Chaimberg, Montreal (CA)

Correspondence Address: OGILVY RENAULT LLP, 1981 MCGILL COLLEGE AVENUE, SUITE 1600, MONTREAL, QC, H3A2Y3, CA

(73) Assignee: The Chaimberg 5 Holdings Inc./Gestion Chaimberg 5 Inc.

(21) Appl. No.: 11/231,816

(22) Filed: Sep. 22, 2005

(51) Int. Cl. B41M 5/00; B32B 3/00; B32B 37/00; B32B 38/04

(52) U.S. Cl. 428/195.1; 156/256; 156/280; 156/250; 428/203

(57) ABSTRACT

A method of fabricating a high-gloss liqui-finish artwork print which comprises the steps of cutting to size a rigid backing material for receiving a printed image paper sheet on a flat surface thereof. The image paper sheet is secured on the surface to create an artwork product. The contour edge of the backing material is treated as per a certain requirement. The backing material with the laminated image paper sheet and the treated contour edge is then transferred to a dust-free and ventilated workspace where there are virtually no air borne contaminants. A coat of clear self-leveling lacquer is deposited on at least the laminated paper sheet of the artwork product. The lacquer coated artwork product is maintained dormant for a period of time sufficient to permit the lacquer to level off and substantially all air bubbles trapped therein to escape. The artwork product is cured under UV lighting for a predetermined period of time to effect complete curing.

### TECHNICAL FIELD

The present invention relates to a method of fabricating high-gloss liqui-finish artwork prints and wherein the surface thereof is reflective and almost resembles a glass-finish surface.

### BACKGROUND ART

It is known to laminate paper prints on a backing material and to then apply a lacquer to the paper print. The paper print can be embossed or the wet lacquer may be brush stroked whereby to imitate that the print is an original artwork painted on canvas. This texture-like surface presents a roughened appearance in a mat finish. These types of prints are very common nowadays and there is a need to provide a new product which is completely different in appearance and using a laminated print on a backing material whereby to satisfy a different customer need.

### SUMMARY OF INVENTION

It is therefore a feature of the present invention to provide a method of fabricating a high-gloss liqui-finish artwork print which as a reflective surface which is very shiny and transparent.

Another feature of the present invention is to provide a laminated artwork print fabricated by that method.

According to a broad aspect of the present invention there is provided a method of fabricating a high-gloss liqui-finish artwork print which comprises the steps of cutting to size a rigid backing material for receiving a printed image paper sheet on a flat surface thereof. The image paper sheet is secured on the surface to create an artwork product. The contour edge of the backing material is treated as per a certain requirement. The backing material with the laminated image paper sheet and the treated contour edge is then transferred to a dust-free and ventilated workspace where there are virtually no air borne contaminants. A coat of clear self-leveling lacquer is deposited on at least the laminated paper sheet of the artwork product. The lacquer coated artwork product is maintained dormant for a period of time sufficient to permit the lacquer to level off and substantially all air bubbles trapped therein to escape. The artwork product is cured for a predetermined period of time to effect complete curing.

According to a further broad aspect of the present invention there is provided an artwork print fabricated in accordance with the above-described method and wherein the artwork print has a rigid MDF backing.

According to a further broad aspect of the present invention the artwork print, produced in accordance with the above referenced method, has a contour wooden frame on which a decorative image is laminated and coordinated with the image on the laminated paper sheet.

### BRIEF DESCRIPTION OF DRAWINGS

A preferred embodiment of the present invention will now be described with reference to the accompanying drawings in which:

FIG. 1A is a perspective view of a high-gloss liqui-finish artwork print laminated on a plaque and fabricated in accordance with the present invention;

FIG. 1B is a section view illustrating the laminated image on an MDF backing board;

FIG. 2 is end view showing the laminated board side edge routed to form a decorative design;

FIG. 3 is an exploded view showing a further method of constructing the artwork print with a contour frame;

FIG. 4 is a perspective view of the finished artwork print constructed in accordance with FIG. 3;

FIG. 5 is a schematic illustration illustrating the process of coating and curing the self-leveling lacquer onto the laminated print; and

FIG. 6 is a flow diagram of the method of fabricating the high-gloss liqui-finish artwork print of the present invention.

### DESCRIPTION OF PREFERRED EMBODIMENTS

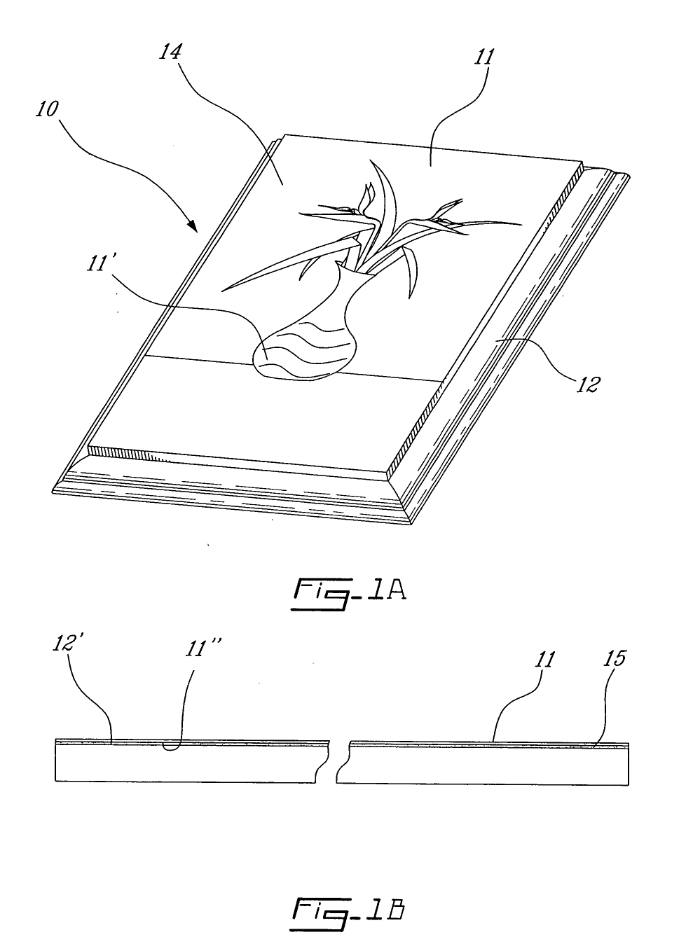

Referring now to the drawings and more particularly to FIGS. 1A, 1B and 2 there is shown generally at 10 an artwork plaque which is comprised of a printed image paper sheet 11 laminated on an MDF backing board 12 which has been routed along its contour edge 13 and treated with the method of the present invention whereby to produce a high-gloss liqui-finish 14 over the image surface 11′ of the paper sheet 11.

The method of fabricating the high-gloss liqui-finish artwork print or plaque 10 as illustrated in FIG. 1A comprises firstly cutting to size a rigid backing material, herein the MDF backing board 12, for receiving and securing the printed image paper sheet 11 over a flat top surface 12′ thereof. A glue 15 is spayed on the back surface 11″ of the paper sheet which is placed on the board 12 and then subjected to heat and pressure whereby to seal the image paper sheet on the backing board 12. This is a well known laminating procedure.

As shown in FIG. 2 the contour edge 13 is then routed to have a decorative shape as illustrated by reference numeral 16 in FIG. 2. This routed contour edge 16 is then painted a suitable color. A hanger hole 17 is also routed in a central top section of the back face 12″ of the MDF backing board 12. Of course this backing board can be any suitable rigid material such as plastic or any solid wood piece or wood composite.

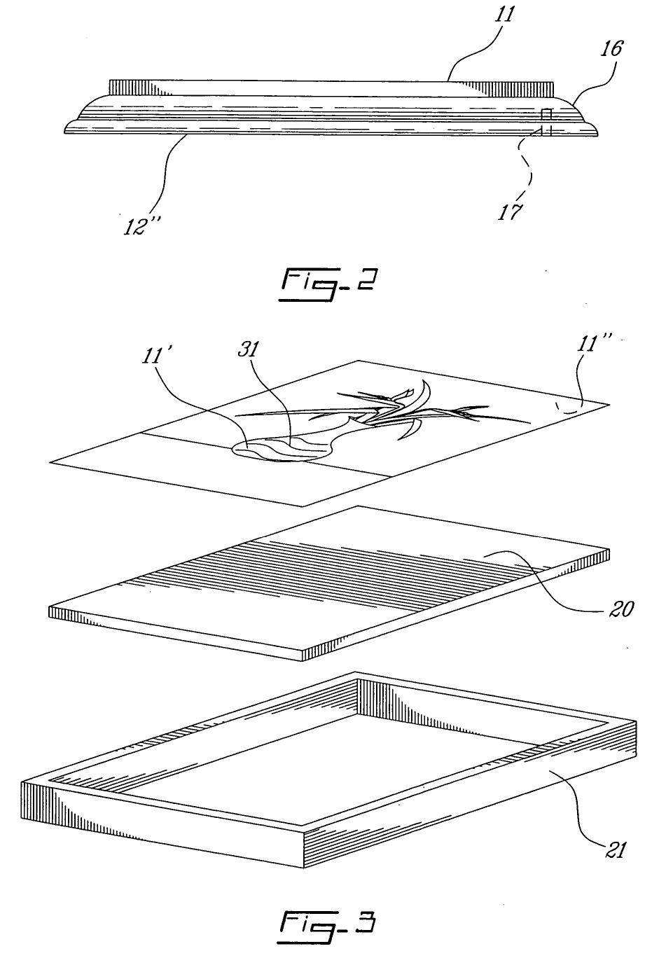

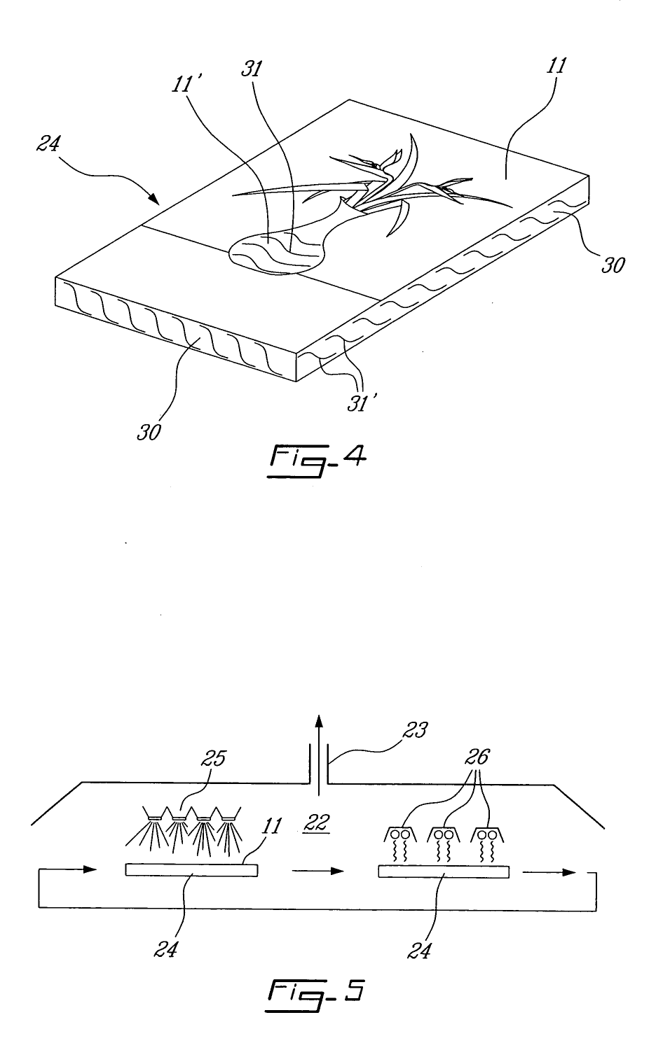

As shown in FIGS. 3 and 4 the backing material may also be constituted by a flat rigid wood board, such as a thin MDF sheet 20 which is secured to a contour wooden frame 21. As herein shown the wood board 20 and the frame 21 are of rectangular configuration but can also be of other shapes. The image paper sheet 11 is then laminated over the backing board 20 as previously described.

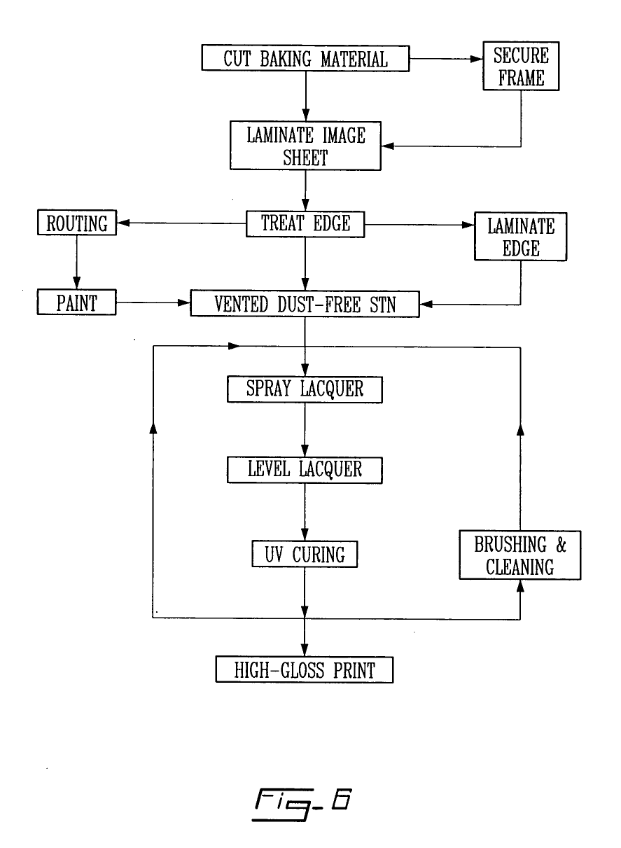

The improvement in the method and artwork print in accordance with the present invention is that a clear lacquer coating is applied to the image sheet to give it a very shiny appearance. To obtain this high-gloss liqui-finish coating the artwork product, namely the image sheet secured on the backing material, is transferred to a dust-free and ventilated workspace, such as schematically illustrated at 22 in FIG. 5. This space is ventilated as schematically illustrated by vent 23 whereby there are no air borne contaminants such as dust or dirt in the air. Also, the fumes generated by the process are vented through the vent 23 to create a safe working environment.

The artwork product 24 is then subjected to a spray coat of clear self-leveling lacquer on at least the laminated image paper sheet 11 thereof. Spraying devices 25 are herein schematically illustrated and are automatically fed this lacquer. Other methods may be envisaged to apply the lacquer. It is important after the lacquer has been applied to the artwork product that the product be maintained dormant for a period of time sufficient to permit the lacquer to level off and to permit substantially all of the air bubbles that are trapped in the lacquer to escape. A period of time of approximately between 5 and 8 minutes has been found to be sufficient to permit the air trapped in the lacquer to escape and the lacquer to level off on the image sheet.

As shown in FIG. 5 the lacquered artwork product 24 is then transferred for curing under UV lights 26 or by other means, such as air drying, and maintained there for a predetermined period of time which is approximately from 3 to 5 minutes. The product can then be optionally brushed with a very light abrasive material and cleaned and then returned under the spray nozzles 25 for application of a second coat of lacquer. The process is preferably, but not exclusively, again repeated where the artwork product is left dormant for the lacquer to level off and for the release of air bubbles trapped therein and then subjected again to the UV curing. The high-gloss liqui-finish artwork print product is now completed.

As shown in FIG. 4 the artwork product 24 is constructed with a frame 21 as illustrated in FIG. 3. A decorative image strip 30 is secured about the frame 21 and has an image coordinated with the printed image 11′ on the paper sheet 11. As herein shown the design 31 in the vase image is reproduced at 31′ in the image strip 30. That image strip is also spayed with the clear self leveling lacquer and cured at the same time as the top image surface to also have a high-gloss liqui-finish.

FIG. 6 is a flow diagram which illustrates the method of fabricating the high-gloss liqui-finish artwork prints as above-described. This Figure is being provided to facilitate the understanding of the method and its various steps depending on the construction of the artwork product.

It is within the ambit of the present invention to cover any obvious modifications of the preferred embodiment described herein, provided such modifications fall within the scope of the appended claims.

I claim:

1. A method of fabricating a high-gloss liqui-finish artwork print comprising the steps of
i) cutting to size a rigid backing material for receiving a printed image paper sheet on a flat surface thereof;
ii) securing said image paper sheet on said flat surface to create an artwork product;
iii) treating a contour edge of said backing material as required;
iv) transferring said backing material with said laminated image paper sheet and treated contour edge to a dust-free and ventilated workspace where there are virtually no air borne contaminants;
v) depositing a coat of clear self leveling lacquer on at least said laminated image paper sheet of said artwork product;
vi) maintaining said lacquer coated artwork product dormant for a period of time sufficient to permit said lacquer to level off and substantially all air bubbles trapped therein to escape; and
vii) curing said artwork product for a predetermined period of time to effect complete curing.

2. A method as claimed in claim 1 wherein there is further provided the step (viii) of repeating steps (v) to (vii).

3. A method as claimed in claim 2 wherein said step (i) comprises cutting a flat rigid wood board and securing same to a contour wooden frame, said contour wooden frame constituting a contour outer edge.

4. A method as claimed in claim 2 wherein said step (ii) comprises spraying glue on a rear surface of said image paper sheet, placing said rear surface of said image paper sheet with said glue on said flat surface of said rigid backing material, and subjecting same to heat and pressure to seal said image paper sheet on said backing material.

5. A method as claimed in claim 1 wherein said step (iii) comprises routing a decorative shape in said contour edge of said backing material, said backing material being a flat rigid wood board.

6. A method as claimed in claim 5 wherein there is further provided the step of painting said contour edge.

7. A method as claimed in claim 5 wherein there is further provided the step of routing a hanger hole in a central top section of a back face of flat rigid wood board.

8. A method as claimed in claim 3 wherein said step (iii) comprises laminating a decorative mage strip over said contour outer edge.

9. A method as claimed in claim 8 wherein said decorative image strip is coordinated with said printed image.

10. A method as claimed in claim 1 wherein said period of time in step (vi) is approximately from between 5 to 8 minutes which is sufficient to permit said air trapped in said lacquer to escape.

11. A method as claimed in claim 10 wherein said curing step (vii) is approximately from 3 to 5 minutes.

12. A method as claimed in claim 1 wherein said step (v) comprises spraying said clear self-leveling lacquer.

13. A method as claimed in claim 1 wherein said step (vii) comprises curing said artwork product under UV lighting.

14. A method as claimed in claim 13 wherein after step (vii) there is further provided the step of brushing said cured coat of lacquer to smoothen said surface, and cleaning said brushed surface prior to said step (viii).

15. An artwork print fabricated in accordance with claim 1 and wherein said artwork print has a rigid MDF backing.

16. An artwork print as claimed in claim 15 wherein said MDF backing is a flat rigid board secured to a contour wooden frame.

17. An artwork print as claimed in claim 16 wherein a decorative image is laminated over an outer surface of said contour wooden frame, said decorative image being coordinated with said printed image in said laminated paper sheet.

18. An artwork print as claimed in claim 15 wherein said lacquer is a clear self-leveling UV-cured lacquer.
